(19) United States
(12) Patent Application Publication
(10) Pub. No.: US 2024/0323328 A1
(43) Pub. Date: Sep. 26, 2024

(54) OPTICAL DISPLAY DEVICE

(71) Applicant: InnerScene Limited, Gloucester (GB)

(72) Inventor: Jonathan Clark, Gloucester (GB)

(73) Assignee: InnerScene Limited, Gloucester (GB)

(21) Appl. No.: 18/614,525

(22) Filed: Mar. 22, 2024

(30) Foreign Application Priority Data
Mar. 24, 2023 (GB) 2304350.8

(51) Int. Cl. H04N 9/76; H04N 9/30; H04N 21/422; H04N 23/12

(52) U.S. Cl. CPC H04N 9/76; H04N 9/30; H04N 23/12; H04N 21/42202

(57) ABSTRACT

A system comprising: an optical display device arranged to create a perception of a sky scene in output light, and a determination system, the optical display device comprising: a diffuse light generation system; an output aperture for the output light, and; electrical circuitry arranged to control the output light, the diffuse light generation system arranged to generate a blue diffuse sky light component in the output light, the determination system arranged to determine a colour of a real-life sky light component of a real-life sky, which is determined separately from a colour of a real-life sun light component of the real-life sky, wherein the electrical circuitry is arranged to control a colour of the diffuse sky light component based on the determined colour of the real-life sky light component.

### TECHNICAL FIELD

The present disclosure relates generally to electrically operated optical display devices for creating an artificial sky light, wherein an observer experiences a perception of a sky scene when gazing into an output aperture of said device.

### BACKGROUND

A device that creates a perception of a real-life sky is provided in EP3181999 A1. Said device generates a collimated light beam from a light source and a collimating lens array. The collimated light beam is transmitted to and through a partially transparent diffuse light generator. A portion of the collimated light beam is scattered by the diffuse light generator by Rayleigh scattering as blue, diffuse light to provide an artificial skylight component and a portion of the collimated light beam passes through the diffuse light generator to provide an artificial sun light component. This device may be implemented as an artificial skylight on an interior wall or ceiling of a building to provide a cost effective alternative to an actual skylight, or to implement a skylight where one is not naturally possible, e.g. in room with no exterior wall. Such devices lack the dynamic realism of a real-life skylight.

Therefore, in spite of the effort already invested in the development of said devices further improvements are desirable.

### SUMMARY

The present disclosure provides a system comprising: an optical display device arranged to create a perception of a sky scene in output light, and a determination system. The optical display device comprises: a diffuse light generation system and/or a collimated light generation system; an output aperture for the output light, and; electrical circuitry arranged to control the output light.

The diffuse light generation system arranged to generate a diffuse cool (e.g. white/blue) sky light component in the output light. The collimated light generation system arranged to generate a collimated warm (e.g. white/yellow) sun light component in the output light. In embodiments, the collimated light generation system comprises a light source and a collimating system for the light source.

In embodiments, the optical display device is arranged as a first sub device with the diffuse light generation system and/or a second sub device with the collimated light generation system. Said first and second sub devices may be integral or separate from each other.

In embodiments, the determination system is arranged to determine a colour of a real-life sky light component of a real-life sky, wherein the electrical circuitry is arranged to control a colour of the diffuse sky light component based on the determined colour of the real-life sky light component of the real-life sky.

By arranging the colour of the diffuse light to vary dependent on the colour of the actual sky light component from an actual sky, the device may create a more realistic virtual sky scene.

In embodiments, the colour of the real-life sky light component is determined separately from a colour of a real-life sun light component. As used herein, the term “determined separately” may refer to the colour either being determined with only the relevant component of the light present with other components isolated therefrom, or determined with other components present but their effect compensated for, e.g. the other components are measured separately and their effect subtracted.

In embodiments, the electrical circuitry is implemented as one or more processors, which are configured to implement the disclosed steps performed by the code reading system (e.g., including determining said validity condition) and/or the steps performed by the processing unit for processing precursor material of the container. The processors may execute program code stored on electronic memory and/or may execute programable logic, e.g., as a logic array, gate array, structured array etc.

In embodiments, the diffuse sky light component is uniform to the extent where it does not vary by more than 10% or 20% or 30% or 40% for any given circular area on the output aperture of 10 mm diameter over at least 90% of the output aperture in terms of one or more of: colour; average direction; luminance; intensity. In embodiments, the diffuse sky light component in the output light has a Lambertian distribution.

In embodiments, the determination system is arranged to determine a colour of a real-life sun light component of a real-life sky, wherein the electrical circuitry is arranged to control a colour of the collimated sun light component based on the determined colour of the real-life sun light component of the real-life sky. In embodiments, the colour of the real-life sun light component is determined separately from a colour of a real-life sky light component.

By arranging the colour of the collimated sun light to vary dependent on the colour of the actual sun light from an actual sky, the device may create a more realistic virtual sky scene.

As used herein the term “based on” in respect of a characteristic of the output light and a characteristic of the real-life sky may refer to the characteristic of the former having some representative dependence on the characteristic of the latter. For example, the representative dependence (for all disclosed characteristics) can be selected so that an observer perceives the characteristic as the same, including substantially the same. Substantially the same may include within the bounds of a the characteristic of the output light that can be produced by the device. The characteristics may be scaled proportionally between these bounds to vary in proportion to perceived characteristics.

With the characteristic exemplified as colour, within the bounds may refer to a bounds of a colour scale/system/gamut that can be reproduced by the device be produced by the device. For example, a maximum or minimum colour that is capable of being produced by the device may be reproduced by the device when the perceived colour extends beyond said maximum or minimum.

The colour may also be scaled proportionally between these maximum and minimum to vary in proportion to the maximum and minimum perceived colours.

With the characteristic exemplified as intensity, within the bounds may refer to a bounds of a intensity, e.g. in lux, that can be reproduced by the device be produced by the device. For example, a maximum or minimum intensity that is capable of being produced by the device may be reproduced by the device when the perceived intensity extends beyond said maximum or minimum. The intensity may also be scaled proportionally between these maximum and minimum to vary in proportion to the maximum and minimum perceived intensity. The intensity may also be scaled to represent a tinted window or skylight.

In embodiments the electrical circuitry is configured to control the colour of the diffuse sky light and/or collimated sun light component to correspond to the colour of the real-life sky light or sun light component of the real-life sky in real-time.

By implementing the associated characteristic in the output light to vary representatively in real time as the characteristic of the real-life sky varies, the optical display device may create a more realistic virtual sky scene. In particular inconsistencies may be minimised between a real-life sky observed from an aperture in a building proximal the artificial sky scene observed from the optical display device.

In embodiments, the colour of the real-life sky light and/or sun light component of the real-life sky is determined using a colour correlated temperature (CCT) or a colour space, including CIE 1931 colour space or other suitable model. By using such a colour system to represent the sky light and/or sun light component the relevant colour may be conveniently identified and stored numerically.

In embodiments, the diffuse light generation system comprises a diffuser, with a second light source coupled to an edge of the diffuser. An edge-lit diffuser may provide a convenient and compact source of the diffuse sky light component.

In embodiments, the diffuser is arranged as a waveguide with elements arranged to decouple the light from the waveguide. A waveguide may conveniently retain the light from the second light source, whilst enabling it to be projected outside of the waveguide diffusively when it encounters an uncoupling feature.

In embodiments, the determination system is arranged to adaptively (e.g. with a variable sampling rate) determine the colour of the real-life sky light and/or sun light component. This may include one or more of: to enter a sleep mode at night time hours (e.g. with reduced sampling or no sampling; to adapt a rate of real-life colour determination based on a rate of colour change or another variable (e.g. power of the light emitted over a given area, which may be referred to as or luminous flux or other variable); to enter a sleep mode between determining the colour (a sleep mode may be defined as a reduced/zero power consumption for one or more of the components implemented by the electrical circuitry, which may include the processes(s). Such a determination system may be energy efficient, which is particularly useful if the determination system is solar or battery powered, and also realistic since if may be able to capture rapid colour changes. In embodiments, the determination system is arranged as a colour sensing system.

In embodiments the colour sensing system comprises: a colour sensor, and; a capturing portion.

The embodiments, the capturing portion arranged (e.g. on a first portion thereof) to receive indirect light (e.g. diffuse light, which may be exclusively received without directly light) as the sky light component from the real-life sky, and a the colour sensor to determine the colour of the indirect light as the diffuse sky light component at the capturing portion.

In embodiments, the capturing portion is arranged to receive at a second portion indirect light and direct light as the sun light component from the real-life sky, and the colour sensor system to determined the colour of the direct light as the collimated sun light component based on the colour of the first and second portion. That is, since the first portion includes only the indirect light/sky light and the second portion includes the indirect light/sky light and the direct light/sun light, both can be used to determine the colour of the direct light/sun light only, e.g. by compensation/correction of the colour of the second portion using the colour of the first portion.

As used herein the term “colour sensor” may refer to an optical system for determining colour, including one or more of: an image capturing unit e.g. a camera system having an image sensor, a Spectrophotometer, a Colorimeter, a Spectroradiometer, a tristimulus colour sensor, a Photodiode or Phototransistor having colour filters, a Charge-coupled device (CCD) or any other device capable of electronically determining colour.

In embodiments, the colour sensing system comprises an isolation member (e.g. arranged to cast a shadow), which is arranged to isolate at (including directly at in operative proximity to) the capturing portion the indirect light from the direct light (which is the sun light component from the real-life sky). In embodiments, the isolation member is elongate along a longitudinal axis, an has a proximal end arranged to received the indirect light and convey, without direct light as the sun light component, the indirect light to a distal end, the distal end operatively coupled to the colour sensor.

In embodiments, the colour sensing system comprises an image capturing unit arranged to capture an image of a real-life sky, and image processing electrical circuitry, which is configured to identify a real-life sky component and/or a real-life sun component in said image and determine a colour thereof. In embodiments, the image capturing unit includes a wide angle lens (including an ultra wide angle lens), which may be capable of providing a convex and/or non-rectilinear appearance).

In embodiments, the determination system comprises: electrical circuitry arranged to determine a colour of a real-life sky component from weather and/or satellite data. For example, the determination system may determine an overcast or clear sky condition from weather and/or satellite data.

In embodiments, the determination system is configured to determine an intensity of the real-life sky light component (which may be determined separately from a real-life intensity of the real-life sun light component) of a real-life sky, wherein the electrical circuitry is arranged to control an intensity of the diffuse sky light component based on the determined intensity of the real-life sky light component.

By arranging the intensity of the diffuse light to vary dependent on the intensity of the actual sky light from an actual sky, the device may create a more realistic virtual sky scene.

In embodiments, the determination system is configured to determine an intensity of the real-life sun light component (which may be is determined separately from a real-life intensity of a real-life sky light component) of a real-life sky, wherein the electrical circuitry is arranged to control an intensity of the collimated sun light component based on the determined intensity of the real-life sun light component.

By arranging the intensity of the collimated sun light to vary dependent on the intensity of the actual sun light from an actual sky, the device may create a more realistic virtual sky scene.

In embodiments, the determination system comprises an angle determination system, which arranged to determine an angle of the real-life sun light component of a real-life sky, wherein the electrical circuitry is arranged to control an angle of projection of the collimated sun light component based on the determined real-life angle of the real-life sun light component with a beam angle adjustment system of the device.

By arranging the angle of the collimated sun light component of the device to vary dependent on the angle of the actual sun light from an actual sky (e.g. the angle relative to some reference system) the device may create a more realistic virtual sky scene, e.g. so that the angle moves to correspond to the sun changing position during the day.

In embodiments, the angle determination system comprises electrical circuitry to determined an angle of the real-life sun light component based on a time of day and a database associating the time of day and a measured angle. Such an approach may be cost effective without requiring physical measurement apparatus

In embodiments, the angle determination system comprises angle sensor arranged to determine an angle of the real-life sun light component. Such an approach may enable the device to be moved without the need to change the time of day and a database.

In embodiments, the determination system is solar powered. By implementing the determination system to be solar powered, it may be powered by the light it measures thus obviating a separate power supply.

In embodiments, the determination system is battery powered. By implementing the determination system to be battery powered it may be more convenient to implement since it does not require connection to a dedicated power supply.

In embodiments, the determination system includes a communication interface for electronic communication with the electrical circuitry of the optical display device via a computer network.

By implementing the determination system to be connected over a computer network to the optical display device, the determination system may be positioned elsewhere, including remote from the device in a more suitable position to measure the light. Moreover, it may be positioned to serve multiple devices.

In embodiments, the communication interface is configured for wireless communication (e.g. Bluetooth Low Energy, Wifi, or one-way radio packet broadcast). By implementing the determination system to use wireless communication in conjunction with solar or battery power, the device can be installed anywhere without requiring wired data or power connection.

In embodiments, the system comprises more than one optical display device per determination system, the electrical circuitry is arranged to obtain a colour of the real-life sun light or sky light of the real-life sky from a proximal most determination system.

The present disclosure provides a system comprising: a one or a plurality of optical display device(s) arranged to create a perception of a sky scene in output light, and one or a plurality of determination system(s). The optical display device is as disclosed in any preceding embodiment or another embodiment disclosed herein.

In embodiments, the determination system(s) arranged to determine one or more of the following characteristics from a real-life sky: a real-life colour of a real-life sky light component; a real-life colour of a real-life sun light component; a real-life intensity of a real-life sky light component; a real-life intensity of a real-life sun light component, and; angle of the real-life sun light component.

In embodiments, the electrical circuitry of the device(s) is arranged to control an associated characteristic based on said one or more determined characteristics. By “associated characteristic” it is meant the corresponding characteristic, e.g. a colour of the sky light component of the real-life sky corresponds to a colour of the diffuse sky light component created by the device etc.

In embodiments the characteristic is received from a proximal most determination system. By controlling a device based on the geographically closest (e.g. with the least straight line distance therebetween) determination system, it may be ensured that the virtual sky scene is created as representatively as possible of the real-life sky.

The present disclosure provides use of a determination system arranged to determine one or more of the following characteristics from a real-life sky: a colour of a real-life sky light component; a colour of a real-life sun light component; an intensity of a real-life sky light component; an intensity of a real-life sun light component, and; an angle of a real-life sun light component, for a device with electrical circuitry configured control an associated quantity a output light based on said one or more determined characteristics.

The present disclosure provides a method of generating an artificial sky scene with output light (e.g. including a perception of a sky scene with infinite depth). The method may implement any feature of any preceding embodiment, or another embodiment disclosed herein. In embodiments, the method comprises: generating a diffuse sky light component in the output light, and/or generating a collimated sun light component in the output light.

In embodiments, the method comprises: determining a colour of a real-life sky light component of a real-life sky, and; controlling a colour of the diffuse sky light component based on the determined colour of the real-life sky light component.

In embodiments the method comprises: determining a colour of a real-life sun light component of a real-life sky, and; controlling a colour of the collimated sun light component based on the determined real-life colour of the sun light component.

In embodiments, the method comprises: determining a angle of a real-life sun light component of a real-life sky, and; controlling an angle of the collimated sun light component based on the determined angle of the real-life sun light component.

In embodiments, the method comprises: determining one or more of the following characteristic from a real-life sky: a real-life colour of a real-life sky light component; a real-life colour of a real-life sun light component; a real-life intensity of a real-life sky light component; a real-life intensity of a real-life sun light component, and; angle of the real-life sun light component; controlling an associated characteristic in the output light based on said one or more determined characteristics.

In embodiments, the method comprises: determining a proximal most determination system, from a plurality of determination systems, and from said proximal most determination system determining a characteristic from a real-life sky; controlling an associated characteristic in the output light based on said determined characteristic.

The preceding summary is provided for purposes of summarizing some embodiments to provide a basic understanding of aspects of the subject matter described herein. Accordingly, the above-described features are merely examples and should not be construed to narrow the scope or spirit of the subject matter described herein in any way. Moreover, the above and/or proceeding embodiments may be combined in any suitable combination to provide further embodiments. Other features, aspects, and advantages of the subject matter described herein will become apparent from the following Detailed Description of Embodiments, Figures, and Claims.

### BRIEF DESCRIPTION OF FIGURES

Aspects, features and advantages of embodiments of the present disclosure will become apparent from the following description of embodiments in reference to the appended drawings in which like numerals denote like elements.

FIG. 1 is a block system diagram showing an embodiment system for creating an artificial sky scene.

FIG. 2 is a block system diagram showing an embodiment optical display device for creating an artificial sky scene of the system of FIG. 1.

FIG. 3 is a side cross-sectional view showing an embodiment of the optical display device of FIG. 2.

FIG. 4 is a block system diagram showing an embodiment determination device for determining a characteristic of light from a real-life sky of the system of FIG. 1.

FIG. 5 is a side cross-sectional view showing an embodiment of the determination system of FIG. 4.

FIG. 6 is a side cross-sectional view showing an embodiment of the determination system of FIG. 4.

FIG. 7 is a side cross-sectional view showing an embodiment of the determination system of FIG. 4.

FIG. 8 is a flow diagram showing an embodiment process implemented by the system of FIG. 1.

### DETAILED DESCRIPTION OF EMBODIMENTS

Before describing several embodiments of the device, it is to be understood that the system is not limited to the details of construction or process steps set forth in the following description. It will be apparent to those skilled in the art having the benefit of the present disclosure that the device is capable of other embodiments and of being practiced or being carried out in various ways.

The present disclosure may be better understood in view of the following explanations:

As used herein the term “optical display device” or “device” may refer to electrically operated optical apparatus that is capable of providing an observer with a perception of a real-life sky when gazing into an output aperture of the device. The device creates a virtual sky scene. The virtual sky scene may have a perception of infinite depth (as for a real-life sky). The device may be dimensioned such that it is suitable for attachment/mounting to a ceiling or wall (e.g. a side wall, including a window) of an interior or a building, e.g., it is less than 1.5 meters or 2 meters or 3 meters in lateral and/or longitudinal dimension; it may be greater than 0.20 or 0.30 meters in lateral and/or longitudinal dimension; it may have a depth of less than 0.5 or 0.3 meters. The output aperture may extend over a substantial amount of the lateral and/or longitudinal dimension of the device, e.g. within a frame that frames the output aperture that has a peripheral width of 0.5-5 cm in said lateral and/or longitudinal dimension.

The device may recreate characteristics of said real-life sky. As used herein, the term “characteristics of a real-life sky” may refer to any optical characteristic of the real-life sky that is capable of measurement and replication in output light from the optical display device. A characteristic may include one or more of the following: a real-life colour of a real-life sky light component; a real-life colour of a real-life sun light component; a real-life intensity of a real-life sky light component; a real-life intensity of a real life sun light component, and; an angle of the real life sun light component. As used herein, the term “intensity” may refer to any quantity related to a brightness perceived by a user, e.g., one or more of a: radiant intensity, measured in watts per steradian (W/sr); luminous intensity, a measured in lumens per steradian (Im/sr), or candela (cd); Irradiance; luminous power, or luminous flux) measured in lumen. As used herein, the term “colour” may refer to a colour measured by a suitable colour system which may enable digital representation, e.g., colour correlated temperature (CCT) or a colour space, including RGB, sRGB, a Pantone collection, CIELAB or CIEXYZ etc. As used herein, the term “real-life colour” may refer to a colour as measured by a colour system, which is assigned, e.g., as an average or other numerical approximation, to an object. The object can be the sun or the sky. Said colour of the object may be measured without interference (including substantial interference) from other objects in the sky scene.

As used herein the term “real-life sky” may refer to a sky view that an observer observes when gazing through a window (e.g., in a side wall or ceiling) of a structure or otherwise from the ground. The portion of the sky view observed typically comprises the sun and surrounding sky, but in some cases, it may only comprise only the former or the latter. Hence a real-life sky may include a real-life sky light component and/or may include a real-life sun light component. The real-life sun light component may include a circular (including substantially circular) yellow/white sun (e.g., a warm colour) and includes direct light. The real-life sky light component includes indirect light from the sun and is absent the real-life sun light component. The real-life sky light component may include: a clear sky component, e.g., a blue/cold colour, and/or; cloud component e.g., a white/grey colour. The clear sky component may surround (including partially or fully) the circular sun. The cloud component can surround and extend over (including partially or fully) the sun.

As used herein “warm” in respect of the sun light component may refer to a yellow and/or white colour. The CCT may be 3000-5000k. As used herein “cold” in respect of the sky light component may refer to a blue and/or white colour. The CCT may be 5000-10000K.

As used herein the term “perception of infinite depth” may refer to a depth of an object (e.g., the sky and/or sun) in three dimensions being perceived as infinitely far away from an observer with stereopsis (e.g., binocular vision). A perception of infinite depth may be provided by one or more of: binocular convergence; motion parallax, and; accommodation visual depth perception cues, e.g., no conflict exists between these visual perception cues. The condition of infinite depth may be determined based on gaze vectors of the eyes of an observer having the same and/or a similar alignment when looking into the device as for looking at the sky and/or sun in the real-life sky. The condition of infinite depth based on motion parallax may be determined based on the image of the sun appearing to be projected from the same location, e.g., moving, as an observer moves laterally and/or longitudinally across the output aperture. An observer user may maintain the same gaze vector associated with infinite depth during said motion.

As used herein the term “sky scene” or “virtual sky scene” may refer to a scene comprising a virtual representation that an observer observes when gazing through the output aperture of the optical display device. A sky scene may include a virtual sky light component and/or may include a virtual sun light component as defined herein. The sky scene may include a circular (including substantially circular) sun coloured image of the sun light component. The sun may be surrounded (including partially or fully) and/or overlapped (including partially or fully) by the sky light component. Alternatively, the sky scene may include the sky light component and no sunlight component.

As used herein the term “perception of a sky scene” may refer an observer perceiving a sky scene as being present in the real world, based on the construction by the device of a virtual sky scene that is sufficiently representative, e.g., in terms of chromatic and spatial distribution of light, to present as in the real-life sky.

As used herein the term “artificial sky light component” or “diffuse light component” may refer to artificial light that is representative of the real-life sky light component (e.g., absent the real-life sun light component), which can include a clear sky component and/or a cloud component (where both components are present the average component may be used) during daylight, sunset or sunrise. It may be representative of the real-life sky light component in respect of one or more of: colour, e.g., as defined by a CCT (e.g., 5000-10000K), the colour may only be blue or optionally white, e.g. to exclude sunrise/sunset conditions; diffusivity; luminance profile or intensity; other suitable parameter, and; a variance of any of the aforesaid over an output aperture of the device. The diffuse light component may be uniform such that is does not vary by more than 10% or 20% or 30% or 40% over the entire output aperture, e.g., in terms of one or more of: colour; luminance (e.g. in candelas per square meter (cd/m2), including luminance profile); intensity, and other suitable parameter. More particularly, said one or more parameters may be uniform to the extent where they do not vary by more than 10% or 20% or 30% or 40% for any given circular area on the output aperture of 10 mm diameter over at least 90% of the output aperture. In a particular example, the diffuse light is propagated over a HWHM solid angle that is at least 4 times larger or 9 times larger or 16 times larger than for the subtending HWHM solid angle of the sun light measured in Sr. The artificial sky light component may have a lumen of 3000-10.000, or 4000-7000. The diffuse sky light component in the output light may have a Lambertian distribution. A Lambertian distribution may refer to a type of diffuse reflection or scattering of light from a surface. The Lambertian model assumes that a surface reflects light uniformly in all directions. This means that the intensity of the reflected light is proportional to the cosine of the angle between the incoming light direction and the surface normal.

As used herein the term “sun light component” or “direct light component” may refer to artificial light that is representative of the real-life sun light component. It may be representative of the real-life sun light component in respect of one or more of: colour, e.g. as defined by a CCT (e.g. 3000-5000k, which is less than that of the sky light component); divergence (e.g. an angle of divergence of the light rays may be no more than 5 or 2 or 1 or 0.5 degrees relative each other); luminance profile or intensity; other suitable parameter, and; a variance of any of the aforesaid over an output aperture of the device. In a particular example, the luminance profile of the sun light may have a narrow peak in the angular distribution around the direction of propagation which is subtended by a HWHM solid angle smaller than 0.2 sr or 0.3 sr. The sun light component may be projected uniformly over the output aperture, e.g., such that an average direction of propagation within a circle of diameter 10 mm at any position over the output aperture does not vary in angle by more than 2 or 5 or 10%. The sun light component may present to a user when looking into the device, as a circular disc positioned at infinity. As used herein the term “collimated light” may refer to light that has been processed by a collimated light generation system, which may form the sun light component.

As used herein the term “output aperture” may refer to a viewing window of the device into which an observer can gaze. The output aperture may be 0.3−2 m×0.3−2 m. The output aperture outputs the output light which is generated by the device. The output aperture may include a transparent member or a void instead of such a member. The output aperture may include a frame that frames the transparent member. As used herein the term “transparent member” may refer to a medium through which the output light is projected. The transparent member may be planar. The transparent member may be formed of glass or plastic or other suitable material.

As used herein the term “reflective member” may refer to an object that is capable of reflecting an image by specular reflection. It can include a member with any surface in which the texture or roughness of the surface is smaller (smoother) than the wavelength of the incident light. It may include surfaces formed of one or more of the following reflective materials: metals; metal oxides, and; dielectric materials. Examples of which include silver, aluminium, a titanium oxide based material including titanium dioxide or titanium trioxide. Any of the aforementioned may be applied as a thin coating on a glass carrier.

As used herein the term “a reflective and partially transmissive member” or “partially reflective member” may refer to a reflective member as defined above, which is additionally configured to transmit therethrough a portion of light which is not reflected. An example of which is a member formed with a lesser thickness than for the aforedescribed reflective material. The transmissivity maybe less than 50% or 30% for incident electromagnetic radiation. The thickness of the reflective material may be any one or the following: less than 700 nm; less than 100 nm; less than 50 nm, and; less than 5 nm, with any of the aforementioned maximum thickness ranges implemented with a minimum thickness of 1 nm.

As used herein the term “output light generation system” may refer to a single (or a distributed system) capable of generating the output light. The output light generation system maybe implemented as a diffuse light generation system and/or a collimated light generation system. The output light generation system may generate all the output light, or part of the output light. For example, output light may also include a portion of light down stream of the output aperture (e.g. other lighting in a room where said device is installed) which is transmitted into the device, via the output aperture, reflected and projected back out.

As used herein the term “diffuse light generator” or “diffuse light generation system” may refer to a single or a distributed system capable of generating the diffuse light component, e.g., light which is scattered at many angles as opposed to one angle as with specular reflection/collimated light. The diffuse light generator may generate the diffuse light component by redirecting/scattering light that is incident/encounters uncoupling/redirecting features. The light may be supplied by a dedicated light source. The diffuse light generator may be at least partially transparent and may at least partially generate the diffuse light component from the light transmitted therethrough (which can include light from the collimated light generation system). The uncoupling features/redirecting features may be implemented as one or more of the following: particles to scatter light; conical micro cones; micro lenses; quantum dots; surface features, including surface etching, and; other suitable implementations. As used herein the term “scattering light” may refer to a process performed on light by the diffuse light generator to generate diffuse light, any may include Rayleigh scattering. As used herein the term “particles to scatter light” may refer to particles with a diameter selected to scatter some or all wavelengths of visible light. The diameter of the particles may be micro or nano (e.g., to operate in the Rayleigh regime). The diffuse light generator can include said particles arranged in a medium, e.g., as a waveguide. Examples include titanium dioxide suspended in PMMA. As used herein the term “light guide panel” or “waveguide” may refer to a generally planar member, which is arranged to convey light in an in-plane direction, e.g., by total internal reflection. The waveguide may be edge lit or otherwise lit by a light source. The waveguide may be implemented as the diffuse light generator, e.g., with a diffuse light component to exit the waveguide upon encountering an uncoupling/redirecting feature.

As used herein the term “light source” may refer to any arrangement capable of generating artificial light. It can include arrangements that transform electrical current into a light emission, e.g. as luminous radiation. The light may have wavelengths in the range of 400-700 nm. The light source can include one or more of the following: a white light source, or perceived as such by the eye, e.g., an incandescent lamp, a fluorescent lamp, a mercury vapor discharge lamp; an LED or a white light laser diode (that is, such that the primary source is combined with a phosphor or several phosphors) or a combination of LEDs or laser diodes of different colour, and; other suitable light source. The light source may include a light guide panel to receive light from an emitting portion and convey the light, e.g., by total internal reflection, to an output surface. The light source may be arranged to emit with a CCT of 3K to 20K, or over a daylight locus. The luminance profile may not vary by more than 20% over any circular area of 10 mm diameter. The light source may include a light guide to guide the light to the output light generation system or the other components of the output light generation system.

As used herein the term “chromatic system” may refer to an arrangement capable of imparting a particular colour to light, e.g., from the light source. The colour may be representative of the real-life colour of sky/sun light component, including daylight, sunset or sunrise. It may for example include a filter.

As used herein the term “collimated light generation system” may refer to a system for processing light from a light source to the collimated light. It may include one or more of the following collimating systems: a lens, including a Fresnel lens; a parabolic reflector; a closed cell structure, through the cells of which light is projected, and; other suitable system. The collimated light generation system may include a light source.

As used herein, the term “prism sheet” or may refer to an arrangement of prisms on a planar member, which maintain an initial degree of collimation of an incident light beam, but which expands said beam. The expansion may be achieved by reflection or reflection and/or refraction. An example of such an arrangement is disclosed in WO2017048569A.

As used herein, the term “electrical circuitry” or “circuitry” or “control electrical circuitry” may refer to one or more hardware and/or software components, examples of which may include: one or more of an Application Specific Integrated Circuit (ASIC) or other programable logic; electronic/electrical componentry (which may include combinations of transistors, resistors, capacitors, inductors etc); one or more processors (e.g. circuitry structure of the processor); a non-transitory memory (e.g. implemented by one or more memory devices), that may store one or more software or firmware programs; a combinational logic circuit; interconnection of the aforesaid. The electrical circuitry may be located entirely at one component of the system, or distributed between a plurality of components of the system (e.g. a server system and/or external device) which are in communication with each other over a computer network via communication resources.

As used herein, the term “computer readable medium/media” or “data storage” may include any medium capable of storing a computer program, and may take the form of any conventional non-transitory memory, for example one or more of: random access memory (RAM); a CD; a hard drive; a solid state drive; a memory card; a DVD. The memory may have various arrangements corresponding to those discussed for the circuitry.

As used herein, the term “processor” or “processing resource” may refer to one or more units for processing, examples of which include an ASIC, microcontroller, FPGA, microprocessor, digital signal processor (DSP), state machine or other suitable component. A processor may be configured to execute a computer program, e.g. which may take the form of machine readable instructions, which may be stored on a non-transitory memory and/or programmable logic. The processor may have various arrangements corresponding to those discussed for the circuitry, e.g. on-board or distributed as part of the system. As used herein, any machine executable instructions, or computer readable media, may be configured to cause a disclosed method to be carried out, e.g. by the system or components thereof as disclosed herein, and may therefore be used synonymously with the term method, or each other.

As used herein, the term “communication resources” or “communication interface” may refer to hardware and/or firmware for electronic information transfer. The communication resources/interface may be configured for wired communication (“wired communication resources/interface”) or wireless communication (“wireless communication resources/interface”). Wireless communication resources may include hardware to transmit and receive signals by radio and may include various protocol implementations e.g. the 802.11 standard described in the Institute of Electronics Engineers (IEEE) and Bluetooth™ from the Bluetooth Special Interest Group of Kirkland Wash. Wired communication resources may include; Universal Serial Bus (USB); Ethernet, DMX, or other protocol implementations. The device may include communication resources for wired or wireless communication with an external device and/or server system.

As used herein, the term “network” or “computer network” may refer to a system for electronic information transfer between a plurality of apparatuses/devices. The network may, for example, include one or more networks of any type, which may include: a Public Land Mobile Network (PLMN); a telephone network (e.g. a Public Switched Telephone Network (PSTN) and/or a wireless network); a local area network (LAN); a metropolitan area network (MAN); a wide area network (WAN); an Internet Protocol Multimedia Subsystem (IMS) network; a private network; the Internet; an intranet; personal area networks (PANs), including with Bluetooth a short-range wireless technology standard.

As used herein, the term “external device” or “external electronic device” or “peripheral device” may include electronic components external to one or more of: the device, and; the server system, e.g. arranged at a same location or remote therefrom, which communicate therewith over a computer network. The external device may comprise a communication interface for electronic communication. The external device may comprise devices including: a smartphone; a PDA; a video game controller; a tablet; a laptop; or other like device.

As used herein the term “database” may refer to a data storage configuration which may be implemented as a key-value paradigm, in which an electronic record as a key and is associated with a value.

As used herein, the term “server system” may refer to electronic components external to one or more of: the device, and; the external device, e.g. arranged at a same location or remote therefrom, which communicate therewith over a computer network. The server system may comprise a communication interface for electronic communication. The server system can include: a networked-based computer (e.g., a remote server); a cloud-based computer; any other server system.

As used herein, the term “determination system” may refer to a system that is able to determine one or more characteristics of a real-life sky. The determination system may be integrated with the optical display device or separate therefrom, including arranged for electronic communication with the optical display device via a computer network, in which communication resources are implemented on the determination system and the optical display device.

As used herein, the term “colour” may refer to a colour measured by a suitable colour system which may enable digital representation, e.g. colour correlated temperature (CCT) or a colour space, including RGB, sRGB, a Pantone collection, CIELAB or CIEXYZ etc.

As used herein, the term “real-life colour” may refer to a colour as measured by a colour system, which is assigned, e.g. as an average or other numerical approximation, to an object. The object can be the sun or the sky. Said colour of the object may be measured without interference (including substantial interference) from other objects in the sky scene.

As used herein, the term “solar powered” may refer to any system that provides electrical energy for operation of a device/system, which is derived from energy of the sun, including a photovoltaic system. Solar powered embodiments may have supporting components such as batteries or capacitors to store accumulated energy between sampling periods and to allow the device to operate during periods of low-light conditions.

As used herein, the term “intensity” may refer to any quantity related to a brightness perceived by a user, e.g. one or more of a: radiant intensity, measured in watts per steradian (W/sr); luminous intensity, a measured in lumens per steradian (Im/sr), or candela (cd); Irradiance; luminous power, or luminous flux) measured in lumen.

As used herein, the term “angle” may refer to a suitable reference defining a position of the sun in the sky, e.g. a solar zenith angle and solar azimuth angle.

As used herein, the term “angle adjustment system” may refer to an arrangement of the optical display device, which is capable of changing the angle of the collimated sun light component in the output light.

### General System Description

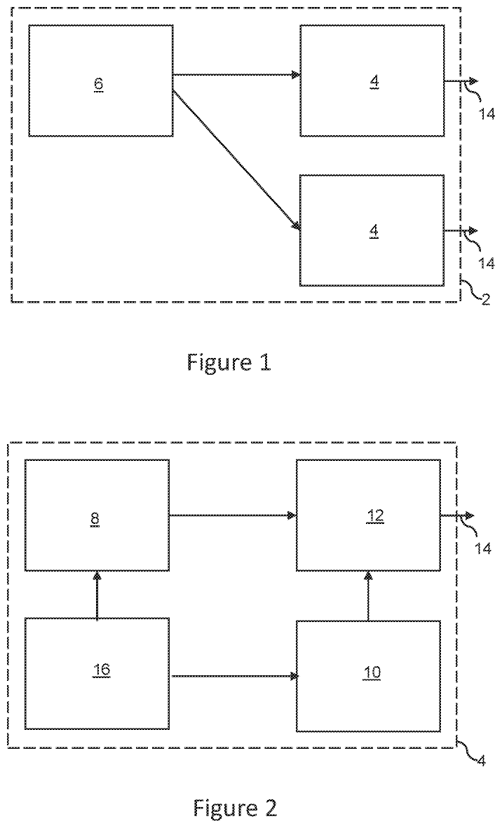

Referring to FIG. 1 a system 2 for creating a virtual sky scene comprises: optical display devices 4, and; a determination system 6 for determining a characteristic of a real-life sky, as will be discussed. In variant embodiments, which are not illustrated, there may be one or more optical display devices and one or more determination systems, as will be discussed.

### Optical Display Device

Referring to FIGS. 1-3, the device 4 comprises: a collimated light generation system 8; a diffuse light generation system 10; an output aperture 12 for output light 14, and electrical circuitry 16 for controlling the various characteristics of the output light 14, including by control of the collimated light generation system 8 and/or the diffuse light generation system 10, as will be discussed.

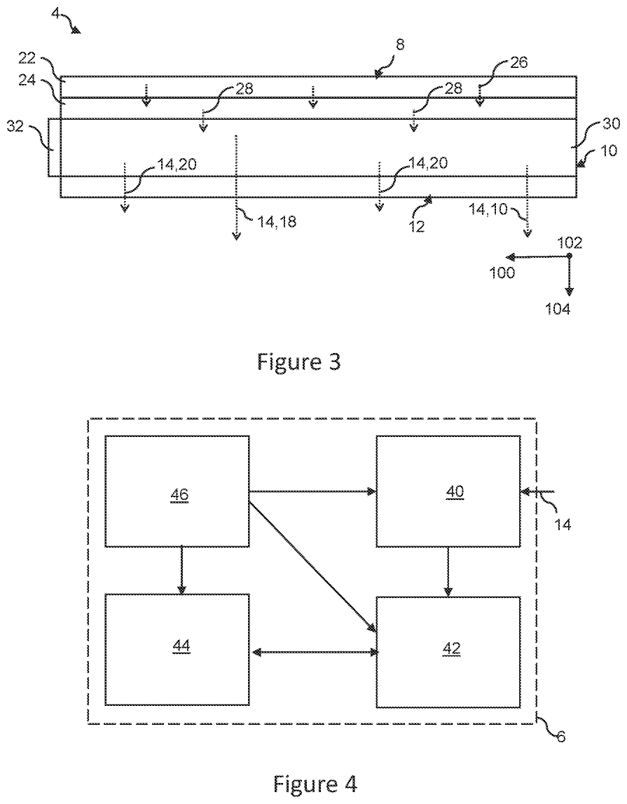

Referring to FIG. 3, the collimated light generation system 8 generates a collimated sun light component 18 in the output light 14. The diffuse light generation system 10 generates a diffuse sky light component 20 in the output light 10.

Referring to FIG. 2, the collimated light generation system 8 includes a light source 22 and a collimating system 24. The light source 22 projects a light beam 26 to the collimating system 24, which processes the received light to output collimated light 28.

The light source 22 is implemented as a 2-dimensional array of LEDs, which can be arranged on a common substrate (not illustrated) and extends in a lateral direction 100 and a longitudinal direction 102. The collimating system 24 is implemented as a 2-dimensional array of lenses (not illustrated), each of which being associated with an LED. A homogenising element (not illustrated) may optionally be implemented subsequent to the collimating system 24 to remove stray light which may be introduced by the collimating system 24 and/or the light source 22, e.g. as an absorbent honeycomb through which the collimated light 28 passes.

In variant embodiments, the collimated light generation system is alternatively implemented, including: as a single or 1-dimensional array of light sources, which are expanded over the output aperture, e.g. by using an expansion system, which can include one or more reflective members and prism sheets, and; the collimating system is alternatively implemented as parabolic reflectors or other collimating systems; the collimated light generation system is implemented as a laser light source, which may obviate the collimating system. The collimated light generation system may also be separate from the diffuse light generation system, e.g. as a spot light, which may be actuator driven for angle adjustment as will be discussed.

The diffuse light generation system 10 includes a transparent member 30 arranged as a waveguide. In the example, the collimated light 28 projects through the transparent member 30 to form the collimated sun light component 18 in the output light 14. The diffuse light generation system 10 includes a dedicated diffuse/second light source 32, which emits light into an edge of the transparent member 30 that extends in a depth direction 100. The transparent member 30 include particles (not illustrated) which scatter the internally reflected light from the light source 32. The light emitted from the light source 32 is retained within the transparent member 30 by total internal reflection until it encounters a particle and is scattered enabling it to exit the transparent member 30 as the diffuse sky light component 20. A portion of the collimated light 18 that encounters a particle may also be scattered in this manner.

In variant embodiments, which are not illustrated: the diffuse light generation system is alternatively configured. For example: it may omit the dedicated second light source, with the diffuse sky light component being provided by the portion of the collimated light that is scattered by the transparent member; the uncoupling features are on an edge of the waveguide, which are configured to decouple the light therefrom; the diffuse light generation system can be arranged in parallel or upstream of the collimated light generation system; the diffuse light generation system comprises a backlit rather than an edge lit arrangement.

Electrical circuitry 16 for control of the output light 14 is arranged on the device 4. In variant embodiments, the electrical circuitry is distributed on one or more components of the system, which can include: the determination system; a peripheral device, and; a server system. Said components can be arranged in electronic communication with each other via the inclusion of a communication interface for communication over a computer network.

The output aperture 12 is planar and is aligned in the longitudinal direction 100 and lateral direction 102. A thickness of the device 4 is arranged in the depth direction 104.

Whilst FIG. 1 illustrates two devices 4 and a single determination system 6, in variant embodiments, which are not illustrated, there may be any number of these components with varying geographical distances between each other.

Moreover, whilst the illustrated device 2 includes both a collimated light generation system 8 and the diffuse light generation system 10, in variant embodiments, which are not illustrated, one of these systems may be omitted. For example, the device 2 may only comprise a diffuse light generation system 10 such that only the diffuse sky light component is present in the output light. It will be understood for such an example that the only characteristics of the real-life sky light of the real-life sky (e.g. and not the real-life sun light) are controlled that the diffuse light generation system is capable of recreating.

### Determination System

The determination system 6 is arranged to determine one or more of the following characteristics from a real-life sky: a colour of a real-life sky light component; a colour of a real-life sun light component; an intensity of a real-life sky light component; an intensity of a real-life sun light component, and; angle of the real-life sun light component. Examples of which will be provided. The electrical circuitry 16 associated with the device 4 is arranged to control the associated quantity in the output light 14 based on said one or more determined characteristics. In particular, the same characteristic (as perceived by a user) can be recreated in the output light 14, including in real time.

Referring to FIG. 4, the determination system 6 includes: a sensor unit 40 to sense the characteristic; electrical circuitry 42 to determine the characteristic; a communication interface 44, and; a power supply 46.

The sensor unit 40 is adapted to the particular characteristic of the real-life sky being determined. Various examples will be proved. In some examples (e.g. where a sensor input is not required in place of a database or numerical calculation) the sensor unit 40 can be omitted.

The electrical circuitry 42 is arranged to determine the characteristic of the real-life sky from an input from the sensor unit 40. The electrical circuitry 42 can be implemented on the determination system 6 or distributed in the system 2, as previously discussed for the electrical circuitry 16 of the device 2.

The communication interface 44 is for electronic communication with the electrical circuitry 16 of the device 2 via a computer network (not illustrated). In variant embodiments, which are not illustrated, in which the determination system 6 is integrated in the device 2, the communication interface may be omitted.

The power supply 46 supplies electrical energy to other the other components of the determination system 6. The power supply 46 is solar powered. In variant embodiments, the solar powered power supply includes a capacitor and/or battery for storing accumulated solar energy. In variant embodiments, other configurations of power supply are implemented, e.g. a battery or a mains electrical connection. In variant embodiments, which are not illustrated, in which the determination system 6 is integrated in the device 2, the power supply may be omitted.

The electrical circuitry 16 of the optical display device 2 receives the characteristic of the real-life sky from the determination system 6 (e.g. from the electrical circuitry 42 via the communication interface 44 over the computer network) and is arranged to control the associated characteristic in the output light 14 based on said received characteristic. Particularly, the characteristic in the output light 14 is matched identically (including substantially identically) so that it is perceived to be the same (including or substantially the same) by an observer, examples will be provided. Alternatively, it may be matched to the extent possible by the optical display device 2.

The communication interface 44 enables the characteristic of the real-life sky to be determined remotely from the device 2. In embodiments where there are multiple determination systems 6 in electronic communication a device 2, the electrical circuitry 16 of the device 2 can be configured to select the characteristic of the real-life sky in various ways.

In a first example, the electrical circuitry 16 selects the characteristic from the closest determination system 6 for which the characteristic is available. In cases where a determination system 6 supplies one or more characteristics, this may include obtaining characteristics across different determination systems 6 or all from the same determination systems 6.

In a second example, electrical circuitry 16 selects the characteristic as an average from several determination systems 6.

The second and first example may also be combined, for example the characteristic may be determined from an average to the two closest determination systems 6 . . .

To determine the closest determination system 6, the electrical circuitry 16 of the device 2 and the electrical circuitry 42 of the determination system 6 can implement a location system, which can comprise: a GPS module; a stored geographical location (e.g. on electronic memory implemented by the electrical circuitry); multilateration systems, and; other such system.

Hence the step of determining the characteristic may include determination the closest one or more determination systems 6 and an optional step of averaging. In the instance of a characteristic not being available from a determination systems 6, a step of obtaining the characteristic from the next closest determination system 6 can be implemented.

The determination system 6 can determine the characteristic with a fixed or an adaptive sampling rate, the latter may be advantageous for reasons of energy consumption and/or accuracy. For example one or more of the following may be combined:
A) to enter a sleep mode (e.g. with reduced sampling or no sampling) at night time hours (e.g. including those defined as geographically dependant after sunset to before sunrise) or when the device 2 is determined by the determination system 6 as not powered on (which can be communicated by the electrical circuitry 16, e.g. when the device is powered on the determination system 6 is notified via the computer network and when powered off it is not notified);
B) to adapt the sampling rate based on a rate of change of the determined or other associated characteristic, e.g. if the characteristic is changing rapidly in value the sampling rate may be increased and also the converse for a slow changing value, and;
C) to enter a sleep mode between determining the characteristic, a sleep mode may be defined as a reduced/zero power consumption for one or more of the components implemented by the electrical circuitry, which may include the processes(s).

In general, the sample rate at the determination system 6 and also the implementation rate of the characteristic by the electrical circuitry 16 of the device 2 is selected to provide a variation in the output light that is sufficient to provide real-time representation, e.g. a 10-300 hz, however other rates are to be contemplated.

### EXAMPLES OF DETERMINATION SYSTEMS

### Example 1—Colour Determination

In a first example, the determination system 6 is arranged as a colour sensing system to determine a colour of a real-life sky light component and/or a real-life sun light component of the real-life sky. The electrical circuitry 16 of the device 2 is configured to control the colour of the diffuse sky light component 20 and/or the colour of the collimated sun light component 18 in the output light 14 to correspond to the determined colour.

The colour of the diffuse sky light component 20 can be controlled by control of the colour of light emitted by the light source 36. The colour of the collimated sun light component 18 can be controlled by control of the light source 22 to effect the colour of light beam 26 emitted by the light source 36.

The colour can be determined and controlled using various suitable colour systems, e.g. colour correlated temperature (CCT) or a colour space. The electrical circuitry 42 of the determination system 6 determines the colour as a value using such a colour system from the input from the sensor unit 40, and transfers it via the computer network to the electrical circuitry 16 of the device 2. The electrical circuitry 16 of the device can control the relevant light source(s) e.g. by a database linking the value of the colour system to the control parameters of the light source(s), so that said value is replicated in the associated component(s) of the output light.

The sensor unit 40 is arranged as a colour sensing unit. Various examples of the colour sensing unit can be implemented:

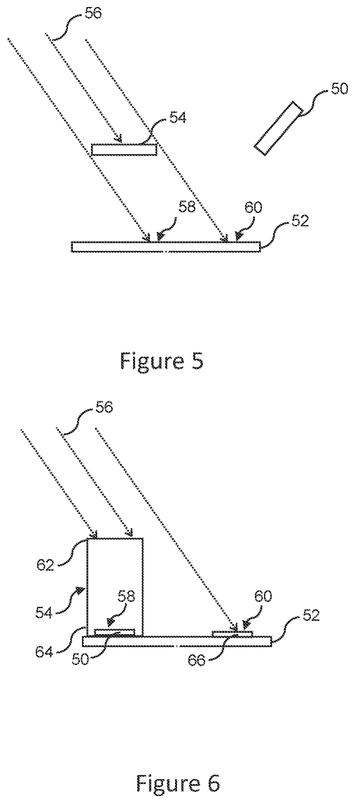

Referring to FIG. 5, in a first example the colour sensing unit of the colour sensing system comprises: an image sensor 50; a capturing portion 52 and an isolation member 54. The capturing portion 52 is arranged to receive light 56 from a real-life sky. The isolation member 54 is interposed between the projection of the light 56 and the capturing portion 52 such that a first portion as a shadow portion 58 is caused on the capturing portion 52, which does not comprise a direct component (e.g. the real-life sun light component) of the light 56 rather only the indirect component (e.g. the real-life sky light component) is present in the shadow. The indirect component may comprise the sky component and/or cloud component depending on the sky. The capturing portion 52 is reflective to the indirect component (e.g. it may be white).

The electrical circuitry 42 using the image sensor 50 is arranged to determine the colour of the rea life sky light component from a colour of the shadow portion 52 (including as an average colour over all or part of the shadow portion). The colour is identified by a value of the relevant colour system, as discussed previously.

In embodiments, where the colour of the real-life sun light component is determined, the electrical circuitry 42 using the image sensor 50 is arranged to determine the colour of the real-life sun light component from a colour of a second portion as a non-shadow portion 60 (including as an average colour over all or part of the non-shadow portion). The colour is identified by a value of the relevant colour system, as discussed previously.

The colour of the non-shadow portion 60 may be corrected based on the determined colour of the shadow portion 58 to ensure that only the colour of the sun light component is provided. In particular, since the non-shadow portion 58 includes: the colour of both the direct/real-life sun light component and the indirect/real-life sky light component, and the shadow portion 58 includes: the colour of just the sun light component, the former can be corrected to remove an effect of the indirect/real-life sky light component as determined by the latter.

The TIAM2 color sensor from MAzet is one example of a suitable and commercially available image sensor 50. The image sensor 50 may comprises at least one filter that matches light responsivity of a human eye. Moreover, the colour sensor may be implemented as first and second sensors, e.g. one for the first and second portion.

In variant embodiments, which are not illustrated, an aperture of the image sensor is arranged as the capturing portion; the image sensor is implemented as other sensors suitable for determining colour, e.g. a camera system or other image capturing device.

Referring to FIG. 6, in a second example which is a variant of the first example (hence for brevity corresponding features and variants are not described), the isolation member 54 is a elongate hollow member which is arranged at an angle to the direct light component of the light 56, such that an indirect component of the light 56 enters the hollow member at the proximal end 62 and travels to the image sensor 50 at the distal end 64 (wherein proximal and distal are defined relative an inlet end). A further image sensor 66 can be arranged external the isolation member to receive the direct and indirect components of the light 56.

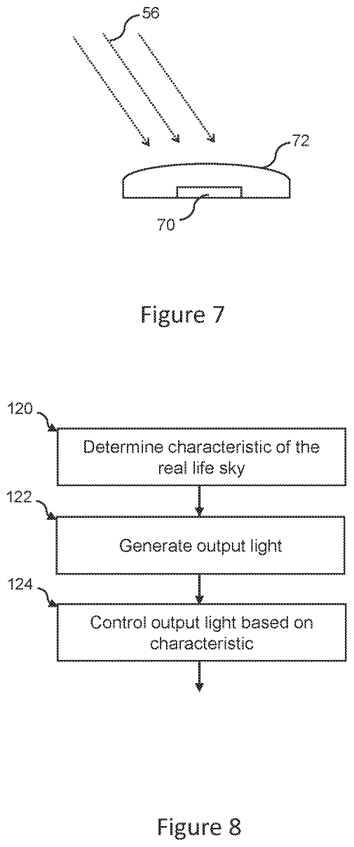

Referring to FIG. 7, in a third example, the colour sensing system comprises an image capturing unit 70 (e.g. a camera system) arranged to capture an image of a real-life sky. The image capturing unit includes an ultra wide angle lens 72, which is capable of providing a non-rectilinear, convex appearance image which may provide a panoramic type image for capturing large areas of the real-life sky. In variant embodiments, other lenses may be implemented, e.g. to provide other image shapes.

Image processing electrical circuitry (not illustrated) is configured to identify in the image a real-life sky light component (e.g. as the blue clear sky component in the image, and/or a white cloud component) and/or a real-life sun light component (e.g. as the white/yellow disk portion in the image) and determine a colour thereof.

The colour (e.g. the value of the relevant colour system, as discussed previously) can be determined by an average of values of the colour system assigned to pixels identified as forming either component. Other techniques may also be implemented, e.g. a non-pixel based approach using larger regions and/or a weighted average based on location in the image. RGB values of an image captured by the camera system can be converted to CCT or XYZ using a calibration corrected linear transformation. Moreover, by detecting over or under exposure and dynamically adjusting a camera's ISO or exposure time, intensities may also be determined, which can be implemented in respect of the second example discussed below.

In a variant of the third example, the electrical circuitry can determine the real-life sky light component as the blue clear sky component in the image in combination with the white cloud component (for when clouds are present). Hence an average (which can include a weighted average based on proportion of both in the image, or the previously discussed technique of summing and averaging the colour values of the pixels across both portions as one overall portion) of the two portions can provide a representative colour that accounts for the presence of clouds in the image.

In a further variant of the third example, the real-life cloud component is determined separately, e.g. as a proportion of the image. This proportion is then created by the device.

In a fourth example, the colour sensing system comprises electrical circuitry (e.g. of the device 4 or distributed over one or more components of the system including as the electrical circuitry 6) arranged to determine a colour of a real-life sky component from weather data (e.g. a degree of cloud/rain etc) and/or satellite data (e.g. a satellite image of cloud conditions)

For example, for the real-life sky light component the determination system may determine an overcast or clear sky condition (hence the blue sky component and/or a white cloud component) from weather and/or satellite data.

For the real-life sun light component the determination system may determine a yellow/white component based on overcast or clear sky condition from weather and/or satellite data. An intensity may also be determined based on overcast or clear sky condition and/or a time of day, which is relevant to Example 2 below,

The light source 32 of the diffuse light generation system 10 may be implemented as a combination of red, green, blue and white LEDs (or other suitable colours/light sources) which are independently controllable to emit light that corresponds to one or more of the determined: clear sky component; cloud component.

### Example 2—Intensity Determination

In a second example, the determination system 6 is arranged as an intensity determination system to determine an intensity of a real-life sky light component and/or a real-life sun light component of the real-life sky. The electrical circuitry 16 of the device 2 is configured to control the intensity of the diffuse sky light component 20 and/or the intensity of the collimated sun light component 18 in the output light 14 to correspond to the determined intensity.

The intensity of the diffuse sky light component 20 can be controlled by control of the power of the light emitted by the light source 36. The intensity of the collimated sun light component 18 can be controlled by control of the power of the light source 22 which affects the intensity of the light beam 26 emitted by the light source 22. Both of which may be controlled by the power of the electrical energy to said light source.

The intensity can be determined and controlled using a suitable measurement parameter, e.g. lumen, radiant flux etc. The electrical circuitry 42 of the determination system 6 determines the intensity as a value using such a measurement parameter from the input from the sensor unit 40, and transfers it via the computer network to the electrical circuitry 16 of the device 2. The electrical circuitry 16 of the device can control the relevant light source e.g. by a database linking the value to the control parameters of the light source so that said value is replicated in the associated component(s) of the output light.

The sensor unit 40 can comprise the colour sensing system of the first example (including any of the examples disclosed in association therewith), in which the image sensor can determine an intensity of the direct or indirect components or a dedicated intensity sensor may be implemented, e.g. a lux meter or photo-diode etc, or the electrical circuitry may determine the intensity from the weather data and/or satellite data.

### Example 3—Angle Determination

In a third example, the determination system 6 is arranged as an angle determination system to determine an angle of a real-life sun light component of the real-life sky. The electrical circuitry 16 of the optical display device 2 is configured to control the angle of the of the collimated sun light component 18 in the output light 14 to correspond to the determined angle.

The angle of the collimated sun light component 18 of the optical display device 2 can be controlled by a beam angle adjustment system (not illustrated). The beam angle adjustment system comprises an actuator to adjust an angle of tilt of the lenses of a lens array of the collimating system 24. The electrical circuitry 16 implements control of said actuator. Other systems may also be implemented, including the previously described spot.

The angle is determined and controlled using a suitable measurement parameter, e.g. a solar zenith angle and solar azimuth angle. The electrical circuitry 42 of the determination system 6 determines the angle as a value using such a measurement parameter, and transfers it via the computer network to the electrical circuitry 16 of the device 2. The electrical circuitry 16 of the device can control the beam angle adjustment system e.g. by a database linking the value to the angle so that said value is replicated in the angle of the collimated sun light component 18 of the output light.

In a first example the electrical circuitry 42 determines an angle of the real-life sun light component based on a time of day and a database associating the time of day and a measured angle. In such an embodiment, the angle determination system may optionally be integrated in the electrical circuitry 16 of the device.

In a second example, a sensor unit 40 is implemented to measure the angle. For example, for the colour sensing system of the first example the angle may be measured based on a position of the shadow portion 58 on the capturing portion 52, which can be determined by the image sensor.

### Process Summary

Referring to FIG. 8, the process implemented by the system 2 comprises:
Block 120: determining one or more of characteristics a real-life sky. This step may include determining a proximal most determination system 6 and/or several determination systems from which to determine the characteristic.
Block 122: generating output light in the device 4. This step may include generation of a diffuse sky light component in the output light, and/or generation of a collimated sun light component in the output light. This step may include generating the output light over several sub-devices.
Block 124: controlling an associated characteristic in the output light based on said one or more determined characteristics.

The process may implement any feature of the previously disclosed embodiments.

As used in this specification, any formulation used of the style “at least one of A, B or C”, and the formulation “at least one of A, B and C” use a disjunctive “or” and a disjunctive “and” such that those formulations comprise any and all joint and several permutations of A, B, C, that is, A alone, B alone, C alone, A and B in any order, A and C in any order, B and C in any order and A, B, C in any order. There may be more or less than three features used in such formulations.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

Unless otherwise explicitly stated as incompatible, or the physics or otherwise of the embodiments, example or claims prevent such a combination, the features of the foregoing embodiments and examples, and of the following claims may be integrated together in any suitable arrangement, especially ones where there is a beneficial effect in doing so. This is not limited to only any specified benefit, and instead may arise from an “ex post facto” benefit. This is to say that the combination of features is not limited by the described forms, particularly the form (e.g. numbering) of the example(s), embodiment(s), or dependency of the claim(s). Moreover, this also applies to the phrase “in one embodiment”, “according to an embodiment” and the like, which are merely a stylistic form of wording and are not to be construed as limiting the following features to a separate embodiment to all other instances of the same or similar wording. This is to say, a reference to ‘an’, ‘one’ or ‘some’ embodiment(s) may be a reference to any one or more, and/or all embodiments, or combination(s) thereof, disclosed. Also, similarly, the reference to “the” embodiment may not be limited to the immediately preceding embodiment.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the present disclosure.

### LIST OF REFERENCES

2 System
4 Device
8 Collimated light generation system
18 Sun light component
22 Light source
26 light beam
24 Collimating system
28 Collimated light
10 Diffuse generation system
20 Sky light component
30 Transparent member
32 Light source
12 Output aperture
14 Output light
16 Electrical circuitry
6 Determination system
40 Sensor unit
Colour sensing system

### Example 1

50 Image sensor
52 Capturing portion
54 Isolation member
56 Light (real-life)
58 Shadow portion
60 Non-shadow portion

### Example 2

54 Isolation member (hollow)
62 Proximal end
64 Distal end
66 Image sensor (second)

### Example 3

70 Image capturing unit
72 Ultra-wide angle lens
42 Electrical circuitry
44 Communication interface
46 Power supply
100 Longitudinal direction
102 Lateral direction
104 Depth direction

1. A system comprising:
an optical display device, which is wall or ceiling mountable, and arranged to create a perception of a sky scene at infinite depth, and a determination system, the optical display device comprising:
a diffuse light generation system;
an output aperture for the output light, and;
electrical circuitry arranged to control the output light,
the diffuse light generation system arranged to generate a diffuse sky light component in the output light,
the determination system arranged to determine a colour of a real-life sky light component of a real-life sky, which is determined separately from a colour of a real-life sun light component of the real-life sky,
wherein the electrical circuitry is arranged to control a colour of the diffuse sky light component based on the determined colour of the real-life sky light component.

2. The system of claim 1, wherein the electrical circuitry is configured to control the colour of the diffuse sky light component to correspond to the colour of the real-life sky light component in real-time.

3. The system of claim 1, wherein the colour of the real-life sky light component is determined using a colour correlated temperature (CCT) or a colour space.

4. The system of claim 1, wherein the diffuse light generation system comprises a diffuser, with a second light source coupled to an edge of the diffuser.

5. The system of claim 4, wherein the diffuser is arranged as a waveguide with elements arranged to decouple the light from the waveguide.

6. The system of claim 1, comprising a collimated light generation system comprising a light source and a collimating system,
the collimated light generation system arranged to generate a collimated sun light component in the output light.

7. The system of claim 6, wherein the determination system is arranged to determine a colour of a real-life sun light component of the real-life sky,
wherein the electrical circuitry is arranged to control a colour of the collimated sun light component based on the determined colour of the real-life sun light component.

8. The system of claim 6, wherein the determination system is configured to determine an intensity of the real-life sun light component,
wherein the electrical circuitry is arranged to control an intensity of the collimated sun light component based on the determined intensity of the real-life sun light component.

9. The system of claim 6, wherein the determination system comprises an angle determination system, which arranged to determine an angle of the real-life sun light component,
wherein the electrical circuitry is arranged to control an angle of projection of the collimated sun light component based on the determined real-life angle of the real-life sun light component with a beam angle adjustment system of the device.

10. The system of claim 1, wherein the determination system comprises:
a colour sensor, and;
a capturing portion arranged to receive indirect light as the sky light component from the real-life sky,
the colour sensor to determine the colour of the indirect light as the diffuse sky light component at the capturing portion.

11. The system of claim 10, wherein the determination system comprises an isolation member, which is arranged to isolate at the capturing portion the indirect light from direct light as the sun light component from the real-life sky.

12. The system of claim 11, wherein the isolation member is elongate along a longitudinal axis, an has a proximal end arranged to receive the indirect light and convey, without direct light as the sun light component, the indirect light to a distal end, the distal end operatively coupled to the colour sensor.

13. The system of claim 1, wherein the determination system comprises an image capturing unit arranged to capture an image of a real-life sky, and image processing electrical circuitry, which is configured to identify a real-life sky component in said image and determine a colour thereof, wherein image capturing unit includes a wide angle lens.

14. The system of claim 1, wherein the determination system comprises:
electrical circuitry arranged to determine a colour of a real-life sky component from weather and/or satellite data.

15. The system of claim 1, wherein the determination system includes a communication interface for electronic communication with the electrical circuitry of the optical display device via a computer network.

16. The system of claim 1, wherein the determination system is solar powered.

17. The system of claim 1, wherein the determination system is arranged to adaptively determine the colour of the real-life sky light component, including one or more of:
to enter a sleep mode at night time hours, in which the real-life colour is not determined or is determined with a reduced sample rate;
to adapt a rate of real-life colour determination based on a rate of colour change or other variable, and;
to enter a sleep mode between determining the colour.

18. The system of claim 1, comprising more than one optical display device per determination system.

19. The system of claim 1, wherein the determination system is configured to determine an intensity of the real-life sky light component,
wherein the electrical circuitry is arranged to control an intensity of the diffuse sky light component based on the determined intensity of the real-life sky light component.

20. The system of claim 1, wherein the electrical circuitry is arranged to obtain the colour of the real-life sky light component from a proximal most determination system of a plurality of determination systems.

21. Use of a determination system arranged to determine a colour of a real-life sky light component of a real-life sky for a device a wall or ceiling mountable device arranged to create a perception of a sky scene at infinite depth with electrical circuitry configured control a colour of a diffuse sky light component in output light based on said determined colour of the real-life sky light component.

22. A method of generating a perception of an artificial sky scene at infinite depth with output light, the method comprising:
determining a colour of a real-life sky light component of a real-life sky, which is determined separately from a colour of a real-life sun light component;
generating a diffuse sky light component in the output light, and;
controlling a colour of the diffuse sky light component based on the determined colour of the real-life sky light component.

23. The method of claim 22 comprising:
determining a colour of a real-life sun light component of a real-life sky, which is determined separately from a colour of the real-life sky light component;
generating a collimated sun light component in the output light, and;
controlling a colour of the collimated sun light component based on the determined real-life colour of the sun light component.

24. A system comprising: one or a plurality of optical display device arranged to create a perception of a sky scene at infinite depth, and a plurality of determination systems, the optical display device comprising:
a diffuse light generation system and/or a collimated light generation system;
an output aperture for the output light, and;
electrical circuitry arranged to control the output light,
the diffuse light generation system arranged to generate a diffuse sky light component in the output light,
the collimated light generation system arranged to generate a collimated sun light component in the output light,
the determination system arranged to determine one or more of the following characteristics from a real-life sky: a real-life colour of a real-life sky light component; a real-life colour of a real-life sun light component; a real-life intensity of a real-life sky light component; a real-life intensity of a real-life sun light component, and; an angle of the real-life sun light component;
wherein the electrical circuitry is arranged to control an associated characteristic in the output light based on said one or more determined characteristic,
wherein the electrical circuitry of the device is arranged to control an associated characteristic based on said one or more determined characteristics received from a proximal most determination system.

25. A method of generating a perception of an artificial a sky scene at infinite depth, the method comprising:
determining a proximal most determination system from a plurality of determination systems, and from said determination system;
determining one or more of the following characteristic from a real-life sky: a real-life colour of a real-life sky light component; a real-life colour of a real-life sun light component; a real-life intensity of a real-life sky light component; a real-life intensity of a real-life sun light component, and; angle of the real-life sun light component,
generating a diffuse sky light component in the output light, and/or generating a collimated sun light component in the output light;
controlling an associated characteristic in the output light based on said one or more determined characteristics.
